(19) United States
(12) Patent Application Publication
(10) Pub. No.: US 2009/0100885 A1
(43) Pub. Date: Apr. 23, 2009

(54) GUARD ANTI-ROTATION LOCK

(76) Inventors: Cornelius Boeck, Kirchheim (DE); Joachim Schadow, Leinfelden-Echterdingen (DE); Sinisa Andrasic, Schoenaich (DE)

Correspondence Address: MICHAEL J. STRIKER, 103 EAST NECK ROAD, HUNTINGTON, NY, 11743, US

(21) Appl. No.: 12/293,386

(22) PCT Filed: Nov. 9, 2007
(86) PCT No.: PCT/EP2007/062120

§ 371 Date: Sep. 17, 2008

(30) Foreign Application Priority Data
Nov. 13, 2006 (DE) 10 2006 053 305.4

(51) Int. Cl. G05G 5/00

(52) U.S. Cl. 70/174

(57) ABSTRACT

The invention relates to a protective hood anti-rotation lock for a portable power tool (12a-k), especially for an angle grinder, for providing anti-rotational locking between the portable power tool (12a-k) and a protective hood unit (14a-k). According to the invention, the protective hood anti-rotation lock has a form-fit unit (16a-k) which is provided for anti-rotational locking of the protective hood unit (14a-k) in relation to the portable power tool (12a-k) in the event of a tool (18a-k) breakage.

### RELATED ART

The present invention is directed to a guard anti-rotation lock device according to the preamble of Claim 1.

An angle grinder with an adjustable guard is made known in EP 812 657 A1. In that case, the guard is adjustable in a rotating manner on a connection piece of a flange of the angle grinder, and is supported such that it may be detachably attached using a single form-fit locking means. The spindle of the angle grinder passes through the center of the flange. A cutting disk and/or grinding disk are/is installed on the free end of the spindle in a clampable, rotationally drivable manner for cutting and machining work pieces, which are partially enclosed by the guard. The guard must be positioned in a rotationally adjustable manner on the hand-held power tool such that the region of the grinding disk that faces the user is enclosed by the guard. At the same time, a region of the grinding disk that points away from the user extends past the flange, radially relative to the region of engagement with the work piece.

### ADVANTAGES OF THE INVENTION

The present invention relates to a guard anti-rotation lock device for a hand-held power tool, in particular for an angle grinder, which is provided to prevent rotation between the hand-held power tool and a guard unit.

It is provided that the anti-rotation lock device includes a form-fit connection unit, which is provided to prevent rotation between the hand-held power tool and the guard unit if a tool should burst. The guard unit is preferably provided to protect an operator—during regular operation of the hand-held power tool—from a tool, in particular from a disk-shaped, rotatably drivable tool, and/or from machining residue that is slung in the direction of the operator, and it is attached to the hand-held power tool in a working position. A “form-fit connection unit” refers, in particular, to a unit that is provided to establish a form-fit connection—that acts in the circumferential direction—between the guard unit and the hand-held power tool, and which is designed to absorb forces of an outwardly-slung tool piece that could occur if a tool should burst. The guard anti-rotation lock device, which in an anti-rotation lock position, is designed to absorb a force of at least 1000 N, advantageously at least 2500 N, and particularly advantageously at least 4500N. To realize an anti-rotation lock of the guard unit on the hand-held power tool, the guard unit, which is attached to the hand-held power tool, may be moved into an anti-rotation lock position by absorbing impulses and/or forces of outwardly-slung pieces of the burst tool. “Provided” is intended to mean, in particular, specially equipped and/or designed. Due to the inventive design of the guard anti-rotation lock device, it is possible to effectively protect an operator of the hand-held power tool from a tool that rotates during operation of the hand-held power tool, and, in particular, from pieces of the tool that are slung in the direction of the operator if the tool becomes damaged, e.g., if the tool should burst.

It is furthermore provided that the form-fit connection unit includes at least one form-fit connection element, which is movably supported on the guard unit and/or the hand-held power tool, thereby enabling the form-fit element to be moved and/or brought into an anti-rotation lock position if a tool should burst, and enabling an anti-rotation lock to be realized between the guard unit and the hand-held power tool via the form-fit connection unit. Removal may also be simplified by designing the form-fit connection unit to be movable out of the anti-rotation lock position so that it may be removed.

It is also provided that the form-fit connection unit is supported on the guard unit such that it is movable around a pivot axis, thereby making it possible to advantageously utilize a transfer of an impulse of an outwardly-slung piece of a burst tool, in order to attain an anti-rotation lock position of the form-fit connection element and/or the guard unit. The form-fit connection element is preferably deflected from its neutral position by an impulse of a tool piece that is transferred to the guard unit, and is moved into an anti-rotation lock position. This may be attained in a particularly advantageous manner when the form-fit connection element is located on a guard of the guard unit, in particular on a side of the guard that faces the tool when in the installed state.

In an advantageous refinement of the present invention, it is provided that the form-fit connection unit includes a guide element in which the form-fit connection element is movably supported, thereby making it possible to realize a particularly specific motion into an anti-rotation lock position, and to realize a low-wear motion of the form-fit connection element.

Additional components, installation space, assembly effort and costs may be advantageously saved when the form-fit connection element is designed at least partially as a single piece with the guard unit and/or the hand-held power tool. In this context, the term “single piece” is intended to mean, in particular, one piece, cast, and/or designed as one component.

If, in addition, the form-fit connection element is formed at least partially by a detent element, it is advantageously possible to prevent the guard unit from rotating, in particular if a tool should burst, and in particular when the detent element is provided to block a motion of the guard unit in at least one direction. A blocking direction of the detent element preferably refers to a direction of rotation of a tool.

In an advantageous refinement of the present invention, it is provided that the form-fit connection unit is movable—together with the guard unit—into an anti-rotation lock position, thereby making it possible to utilize energy from a piece of a burst tool that was transferred to the guard to change the position of the form-fit connection element to the anti-rotation lock position. An “anti-rotation lock position” refers, in particular, to a position of the guard unit relative to the hand-held power tool in which the guard unit is oriented opposite to a rotation, in particular a direction of rotation of the tool on the hand-held power tool, in particular on a receiving flange. This may be attained in a particularly advantageous manner when the form-fit connection element is provided to couple to the guard unit in an at least partially non-positive manner. A coupling may take place directly, or indirectly via a driving element and/or further components that appear reasonable to one skilled in the technical art.

It is also provided that the form-fit connection element includes at least one driving element, which is provided to drive at least one form-fit connection element into an anti-rotation lock position together with the guard unit, thereby making it possible to attain a deliberate change of position of the form-fit connection element into an anti-rotation lock position if a tool should burst.

It is possible to advantageously realize a driving of the form-fit connection element via the driving element into an anti-rotation lock position if a tool should burst when the driving element is provided to couple at least partially to the guard unit in a circumferential direction, the guard unit preferably undergoing a motion into an anti-rotation lock position along a direction of rotation of the tool due to a transfer of kinetic energy of an outwardly-slung piece of a burst tool. This may be attained using a simple design when the driving element is designed as an intermediate ring located between the guard unit and the hand-held power tool, and/or by a rolling element, and/or by further driving elements that appear reasonable to one skilled in the technical art.

It is furthermore provided that the form-fit connection unit includes at least one release-prevention mechanism, which is provided to fix at least one driving element and/or one form-fit element in a neutral position before an anti-rotation lock, thereby making it advantageously possible to prevent and/or block an installation procedure and/or a removal procedure of the guard unit using the form-fit connection element during installation or removal of the guard unit on the hand-held power tool. In this context, a “release-prevention mechanism” refers, in particular, to a securing of a form-fit element and/or a driving element that is provided to fix the form-fit element or the form-fit element together with the driving element in a neutral position during regular operation of the hand-held power tool system, and/or in a switched-off operating mode of the hand-held power tool, and, when a stronger force is applied, in particular by a piece of a tool that has burst during operation of the hand-held power tool and that strikes the guard unit, a motion of the form-fit connection element is released out of its neutral position and into an anti-rotation lock position.

An advantageous and, in particular, exact starting position of the form-fit element before an anti-rotation lock if a tool should burst may be advantageously attained when the form-fit connection unit includes at least one retaining element, which is provided to secure the form-fit connection element in a position in front of the anti-rotation lock. This may be attained in a manner with a particularly simple design when the retaining element is designed as a spring element.

In a further embodiment of the present invention, a hand-held power tool system is provided that includes a hand-held power tool, in particular an angle grinder, a guard unit, and a guard anti-rotation lock device, in which case the guard anti-rotation lock device includes a form-fit connection unit, which is provided to prevent the guard unit from rotating relative to the hand-held power tool if a tool should burst. As a result, it is possible to effectively protect an operator of the hand-held power tool from a tool that rotates during operation of the hand-held power tool, and/or, in particular, from pieces of the tool that are slung in the direction of the operator if the tool becomes damaged, e.g., if the tool should burst. To attain an anti-rotation lock of the guard unit on the hand-held power tool, the guard unit, which is attached to the hand-held power tool, may be moved into the anti-rotation lock position by absorbing forces of impulses and/or forces of outwardly-slung pieces of the burst tool.

It is furthermore provided that the hand-held power tool includes a receiving unit, which is provided at least partially to movably support the form-fit connection element, thereby making it possible to at least partially realize a particularly compact positioning of the form-fit connection unit.

It is also provided that the hand-held power tool includes a receiving unit with an intermediate ring on which the form-fit connection element is at least partially located, thereby making it possible to replace the form-fit connection element—using a simple design—if deformation should occur after a form-fit connection is established between the guard unit and the hand-held power tool if a tool should burst.

When the form-fit connection unit includes at least two form-fit connection elements, which are located one after the other in the circumferential direction on a receiving unit of the hand-held power tool and/or the guard unit, it is possible to realize a reusable form-fit and/or non-positive connection between the guard unit and the receiving unit, and/or the guard unit may be installed on the receiving unit in different positions along the circumferential direction in a non-rotating manner, in particular if a tool should burst. The term “circumferential direction” is intended to mean, in particular, a circumferential direction of the guard unit, which is oriented essentially parallel to a direction of rotation of the tool when the guard unit is in an installed state.

Particularly advantageously, the present invention includes a hand-held power tool for a rotating, preferably disk-shaped tool, with a machine housing that includes a flange and/or a machine neck, on which a guard—that is composed of sheet metal in particular—is detachably clampable in order to cover the tool. The guard includes a guard body, which is composed of a circular, disk-shaped piece, in particular with an outer edge located at a right angle thereto, and with a central, circular recess, on the edge of which a guard connection piece and/or collar is formed and that includes an annular clamping band that may be tightened using a clamping means. An anti-rotation lock that acts between the machine neck and the guard is located between the guard and the machine neck and is designed as a profiled structure. The guard may be repeatedly coupled via the clamping band and/or the clamping means in its clamping position in a form-fit and/or non-positive manner with the machine neck, and is therefore capable of being fixed in a non-rotatable position and, to attain a release position, may be disengaged from the form-fit and/or non-positive connection, so that the guard may then be adjusted in a rotational manner.

### DRAWING

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

FIG. 1 shows an exploded view of an inventive hand-held power tool system,

FIG. 2 shows a guard anti-rotation lock device with a form-fit connection element, in a schematic, partial cross-sectional view,

FIG. 3 shows a guard anti-rotation lock device with a form-fit connection element that is an alternative to that shown in FIG. 2, in a schematic, partial cross-sectional view,

FIG. 4 shows a guard anti-rotation lock device with a form-fit connection element that is movably supported in a guide element, in a schematic, partial cross-sectional view,

FIG. 5 shows a guard anti-rotation lock device with a form-fit connection element designed as a chain, in a schematic, partial cross-sectional view,

FIG. 6 shows a guard anti-rotation lock device with a folded form-fit connection element, in a schematic, partial cross-sectional view,

FIG. 7 shows a guard anti-rotation lock device with a pivotably supported form-fit connection element, in a schematic, partial cross-sectional view,

FIGS. 8a and 8b show a guard anti-rotation lock unit with an intermediate ring and a form-fit connection element, in a schematic side view (FIG. 8a), and in a perspective view (FIG. 8b),

FIG. 9 shows a guard anti-rotation lock device with a driving element designed as an intermediate ring, in a schematic, partial cross-sectional view,

FIG. 10 shows a guard anti-rotation lock device with a form-fit connection element designed as a single piece with an intermediate ring, in a schematic, partial cross-sectional view,

FIGS. 11a and 11b show a guard anti-rotation lock unit with a form-fit connection element that is movable perpendicularly to a direction of rotation, in a first schematic, partial cross-sectional view (FIG. 11a), and in a second, schematic partial cross-sectional view (FIG. 11b), and

FIG. 12 shows a guard anti-rotation lock device with a form-fit connection element designed as a single piece with a receiving unit, in an exploded view.

### DESCRIPTION OF THE EXEMPLARY EMBODIMENTS

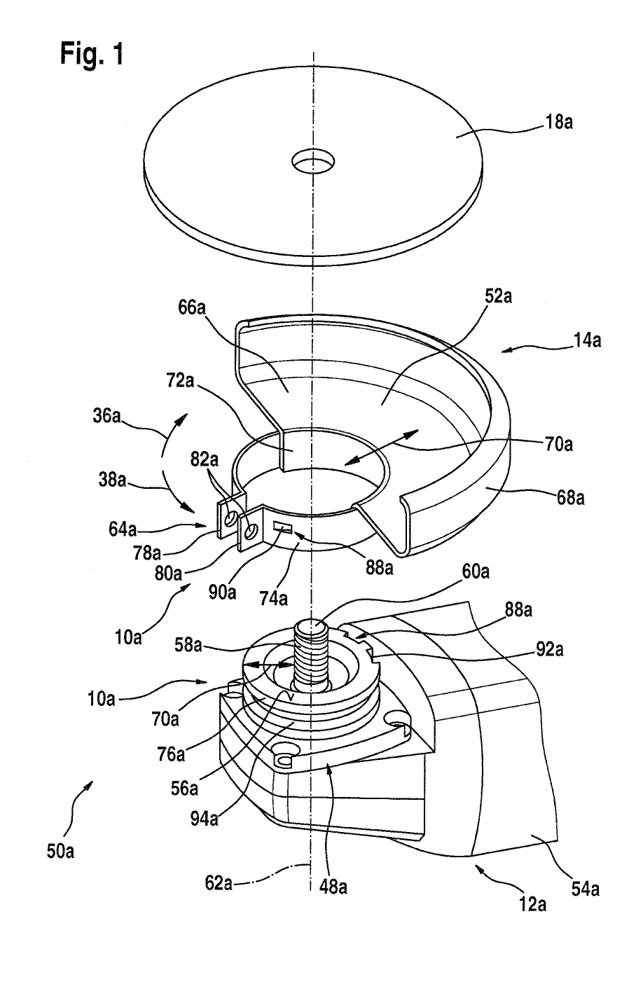

FIG. 1 shows a hand-held power tool system 50a with a hand-held power tool 12a designed as an angle grinder and shown only partially here, and with a guard unit 14a and a guard anti-rotation lock device 10a. Hand-held power tool 12a includes a hand-held power tool housing 54a, and a receiving unit 48a for receiving guard unit 14 and/or a tool 18a designed as a cutting disk, receiving unit 24a being screwed together with hand-held power tool housing 54a. A drive shaft 58a extends out of receiving unit 48a on a side 56a facing away from hand-held power tool housing 54a. Drive shaft 50a is connectable at its free end 60a with disk-shaped tool 18a and is rotationally drivable around an axis 62a. Guard unit 14a includes a guard 52a and a closing unit 64a. When hand-held power tool system 50a is in an installed state, guard 52a extends around an angular range of tool 18a of approximately 180° and, to this end, includes a semi-disk shaped guard body 66a and a guard edge 68a, which is initially oriented perpendicularly to semi-disk shaped body 66a and is finally oriented parallel to semi-disk shaped guard body 66a, inwardly in a radial direction 70a.

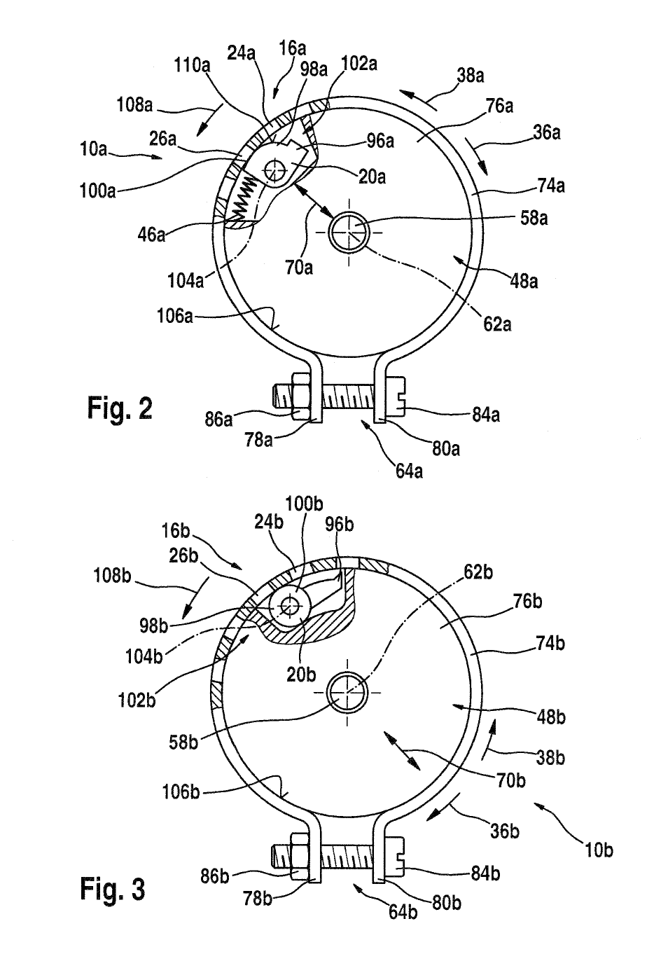

Guard unit 52a also includes a guard collar 72a, which is oriented essentially perpendicularly to semi-disk shaped guard body 66a. Guard collar 72a is enclosed outwardly in radial direction 70a by a clamping band 74a of closing unit 64a. Guard collar 72a and clamping band 74a are interconnected via a welded connection. Guard collar 72a—together with clamping band 74a—is provided to attach guard unit 14a to hand-held power tool 12a and/or to receiving unit 48a, which includes a cylindrical receiving flange 76a for this purpose. Along a circumferential direction 36a, 38a of clamping band 74a, clamping band 28a includes two end regions 78a, 80a in a region that faces away from guard 52a and extends outwardly in radial direction 70a. End regions 78a, 80a each include a recess 82a, through which a closing element 84a—designed as a clamping screw—of closing unit 64a extends (see FIG. 2). The clamping screw may be fastened in recesses 82a of clamping band 74a using a nut 86a. Guard 52a is attached in a working position to receiving unit 48a and/or on receiving flange 76a via closing unit 64a using a frictional connection between guard collar 72a and clamping band 74a and receiving flange 76a, so that guard unit 14a is positioned in a non-rotatable manner during regular operation of hand-held power tool 12a. In an alternative design of closing unit 64a, it is basically feasible to use—instead of the clamping screw—further closing elements, e.g., a clamping lever and/or form-fit elements, etc.

Hand-held power tool system 50a also includes a coding device 88a, which is provided to prevent tools 18a and/or tools 18a together with guard unit 14a from being installed on unsuitable hand-held power tools 12a. To this end, clamping band 74a includes a coding element 90a of coding device 88a, which is designed as a single piece with clamping band 74a. Coding element 90a is designed as a pressed-out region that extends inwardly in radial direction 70a and has a rectangular shape. Correspondingly, receiving flange 76a includes a coding element 92a of coding device 88a, which is designed as a recess into which coding element 90a of clamping band 74a may be inserted when guard unit 14a is installed on hand-held power tool 12a. After guard unit 14a has been inserted onto receiving unit 48a, guard unit 14a may be rotated into a working position. To this end, receiving flange 76a includes a groove 94a that extends in circumferential direction 36a, 38a, in which coding element 90a is guided when guard unit 14a is rotated into the working position.

FIG. 2 shows guard anti-rotation lock device 10a in FIG. 1 in greater detail. Guard anti-rotation lock device 10a is provided to prevent rotation between guard unit 14a and hand-held power tool 12a and/or receiving unit 48a during a breakdown of tool 18a, e.g., when a tool 18a bursts. To this end, anti-rotation lock device 10a includes a form-fit connection unit 16a, which is provided to prevent rotation in a form-fit manner between hand-held power tool 12a and guard unit 14a if a tool 18a should burst. Form-fit connection unit 16a includes a form-fit connection element 20a, which is located inside receiving flange 76a, and several form-fit connection elements 24a, 26a, which are located one after the other in circumferential direction 36a, 38a on clamping band 74a and/or guard collar 72a of guard unit 14a. Form-fit connecting elements 24a, 26a of guard unit 14a are designed as recesses.

Form-fit connecting element 20a of receiving flange 76a includes a hook element 96a and a subregion 98a, which is designed as a rolling element 100a. In addition, form-fit connection element 20a is located on an edge region 102—located outwardly in radial direction 70a—of receiving flange 76a such that it may rotate around rotation axis 104a. When guard unit 14a is in a working position, subregion 98a of form-fit connection element 20a designed as rolling element 100a bears against a surface 106a—that faces inwardly in radial direction 70a—of clamping band 74a and/or guard collar 72a. Form-fit connection element 20a couples in a non-positive manner to clamping band 74a and/or guard collar 72a. Form-fit connection element 16a also includes a retaining element 46a, which is designed as a spring element and holds form-fit connection element 20a in a position before an anti-rotation lock. It is also feasible for form-fit connection element 20a to be located—due to its design in radial direction 70a—in receiving unit 48a in a form-fit manner.

If a tool 18a should burst during operation of hand-held power tool 12a, tool pieces are slung outwardly in a rotation direction 108a of tool 18a. If one of these tool pieces strikes guard unit 14a, the kinetic energy of the tool piece transferred to guard unit 14a exceeds the attachment energy of the frictional connection of closing unit 64a between guard unit 14a and hand-held power tool 12a. Guard unit 14a is then rotated out of its working position and in rotation direction 108a of tool 18a. Form-fit connection element 20a, which couples on surface 106a—which faces inward in radial direction 70a—of clamping band 74a and/or guard collar 72a in a non-positive manner, is rotated around rotation axis 104a in rotation direction 108a. Due to a motion of guard unit 14a, form-fit connection element 20a and/or subregion 98a of form-fit connection unit 20a designed as rolling element 100a walk(s) around clamping band 74a and/or guard collar 72a, so that form-fit connection element 20a is moved together with guard unit 14a. In addition, it is also feasible for surface 106a—which faces inward in radial direction 70a—of clamping band 74a and/or guard collar 72a, and/or an outer surface 110a of subregion 98a designed as rolling element 100a to have a high friction coefficient in order to increase a non-positive connection between form-fit connection element 20a and clamping band 74a and/or guard collar 72a due to a special material selection and/or a special surface treatment.

Due to the rotation of form-fit connection element 20a, hook element 96a is rotated outwardly, and thereby extends through one of the recesses in clamping band 74a and/or guard collar 72a. As soon as a form-fit connection is established between form-fit connection element 20a supported in receiving unit 48a and one of the form-fit connection elements 24a, 26a of clamping band 74a and/or guard collar 72a, guard unit 14a is located in an anti-rotation lock position relative to hand-held power tool 12a. In a further embodiment of the present invention, it is feasible to increase the number of form-fit connection elements 20a, 24a, 26a and/or to change a location of form-fit connection element 20a within receiving unit 48a in a manner that appears reasonable to one skilled in the technical art.

Alternative exemplary embodiments are shown in FIGS. 3 through 12b. Components, features, and functions that are essentially the same are labelled with the same reference numerals. To distinguish the exemplary embodiments from each other, the reference numerals of the exemplary embodiments are appended with the letters a through k. The description below is essentially limited to the differences from the exemplary embodiment in FIGS. 1 and 2. With regard for the components, features, and functions that remain the same, reference is made to the description of the exemplary embodiment in FIGS. 1 and 2.

FIG. 3 shows an alternative embodiment of guard anti-rotation lock device 10b Guard anti-rotation lock device 10b includes a form-fit connection unit 16b, which is provided to prevent rotation between a guard unit and a receiving unit 48b of a hand-held power tool if a tool should burst. Form-fit connection unit 16b includes a form-fit connection element 20b, which is rotatably supported inside receiving unit 48b. Form-fit connection element 20b differs from the embodiments shown in FIG. 2 in that a hook element 96b for establishing a form-fit connection between the hand-held power tool and the guard unit is reinforced in this case, thereby resulting in earlier engagement in a form-fit connection element 24b, 26b of the guard unit. A further embodiment of form-fit connection unit 16b and/or the guard anti-rotation lock device, and a mode of operation of guard anti-rotation lock device 10b are similar to those described with reference to FIG. 2.

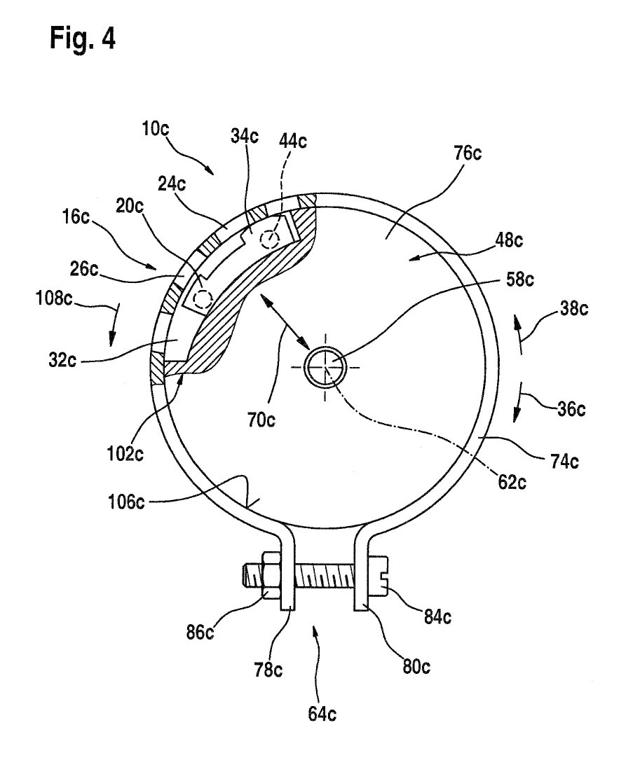

FIG. 4 shows an alternative embodiment of guard anti-rotation lock device 10c. Guard anti-rotation lock device 10c includes a form-fit connection unit 16c, which is provided to prevent rotation between a guard unit and a receiving unit 48c of a hand-held power tool if a tool should burst. Form-fit connection unit 16c includes a form-fit connection element 20c that is movably supported in receiving unit 48c, and several form-fit connection elements 24c, 26c located one after the other in a circumferential direction 36c, 38c. Form-fit connection element 20c of receiving unit 48c is designed as a single piece with driving element 34c. Form-fit connection element 20c in located in a rotation direction 108c of a tool, downstream of driving element 34c. Driving element 34c—together with form-fit connection element 20c—is also fixed in a neutral position—before an anti-rotation lock is implemented—relative to receiving unit 48c via a release-prevention mechanism 44c, only a portion of which is shown. Driving element 34c couples in a non-positive manner to a clamping band 74c and/or a guard collar of guard unit if the guard unit should rotate when in an installed state. In addition, receiving unit 48c includes a guide element 32c—which is tapered in rotation direction 108c—of form-fit connection unit 16c, in which form-fit connection element 20c is movably supported. Guide element 32c is designed as a guide groove and is located in an outer—in radial direction 70c—edge region 102c of a receiving flange 76c. If a tool should burst, the guard unit is rotated out of its working position and in rotation direction 108c. An impulse of the guard unit in rotation direction 108c is greater than a force of release-prevention mechanism 44c, thereby enabling form-fit connection element 20c to be moved together with driving element 34c and the guard unit, also in rotation direction 108c. Due to the tapered design of guide element 32c, form-fit connection element 20c is also moved outwardly in radial direction 70c and engages in one of the form-fit connection elements 24c, 26c of the guard unit.

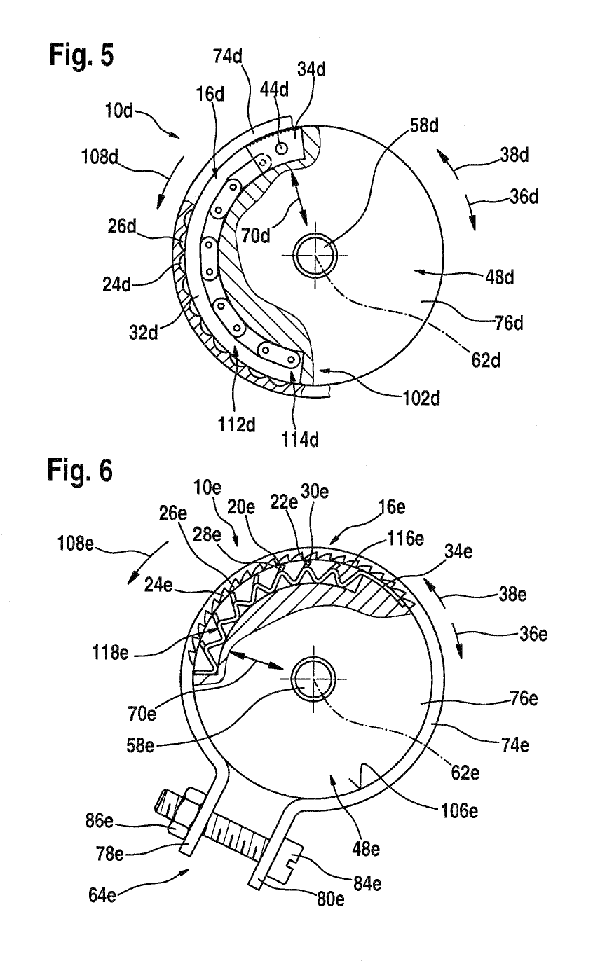

FIG. 5 shows an alternative embodiment of guard anti-rotation lock device 10d. Guard anti-rotation lock device 10d includes a form-fit connection unit 16d, which is provided to prevent rotation between a guard unit and a receiving unit 48d of a hand-held power tool if a tool should burst. Form-fit connection unit 16d includes several form-fit connection elements 24d, 26d, which are located one after the other in a circumferential direction 36d, 38d, each of which is formed by a recess that extends outwardly in a radial direction 70d and is located on a clamping band 74d and/or a guard collar of the guard unit. Moreover, receiving unit 48d includes a further form-fit connection element 20d of form-fit connection unit 16d, which is movably supported in a guide element 32d—designed as a guide groove—of receiving unit 48d. The guide groove is located in an outer—in radial direction 70d—edge region 102d of a receiving flange 76d. Form-fit connection element 20d is designed as a chain and is fixedly located on a driving element 34d designed as a sliding carriage. Driving element 34d is fixed in a neutral position—before an anti-rotation lock is implemented—relative to receiving unit 48d via a release-prevention mechanism 44d, only a portion of which is shown. Moreover, a link of the chain is fixed in position in an end region 114d facing away from driving element 34d, so that the chain—together with driving element 34d—extends along circumferential direction 36d, 38d along the entire length of the guide groove. If a tool should burst, driving element 34d couples in a non-positive manner to clamping band 74d and/or the guard collar, and is moved—together with the guard unit—when rotation occurs in rotation direction 108d due to a piece of a burst tool striking the guard unit, as described with reference to FIG. 4. As a result, a region 112d that is present within the guide groove of the chain is reduced along rotation direction 108d, so that individual links in the chain move toward each other and thereby fold up relative to each other. Individual links engage in form-fit connection elements 24d, 26d—designed as recesses—of the guard unit and bring about an anti-rotation lock of the guard unit.

FIG. 6 shows an alternative embodiment of guard anti-rotation lock device 10e. Guard anti-rotation lock device 10e includes a form-fit connection unit 16e, which is provided to prevent rotation between a guard unit and a receiving unit 48e of a hand-held power tool if a tool should burst. Form-fit connection unit 16e includes several form-fit connection elements 24e, 26e, which are located one after the other in a circumferential direction 36e, 38e, each of which is formed by a detent recess and is located on a clamping band 74e and/or a guard collar of the guard unit. The detent recesses include a detent bevel, which extends outwardly away from a surface 106e—which faces inwardly, in radial direction 70e—of clamping band 74e and/or the guard collar, and opposite to a rotation direction 108e of a tool. Receiving unit 48e also includes several form-fit connection elements 20e, 22e located one after the other in circumferential direction 36e, 38e, each of which is designed as a detent element 28e, 30e. Detent elements 28e, 30e are designed as single pieces with a folded sheet-metal element 116e, and they are located in an outer—in radial direction 70e—fold region 118e of sheet-metal element 116e. Sheet-metal element 116e includes a driving element 34e and fold region 118e, and extends along circumferential direction 36e, 38e over an entire length of a guide element 32e of receiving unit 48e. Moreover, detent elements 28e, 30e extend diagonally in radial direction 70e, outwardly and opposite to rotation direction 108e, so that they may engage in the detent recesses in a form-fit manner and block a motion of the guard unit relative to the hand-held power tool in rotation direction 108e if a tool should burst. An anti-rotation lock brought about using form-fit connection elements 20e, 22e, 24e, 26e and driving element 34e if a tool should burst takes place as described with reference to FIG. 5.

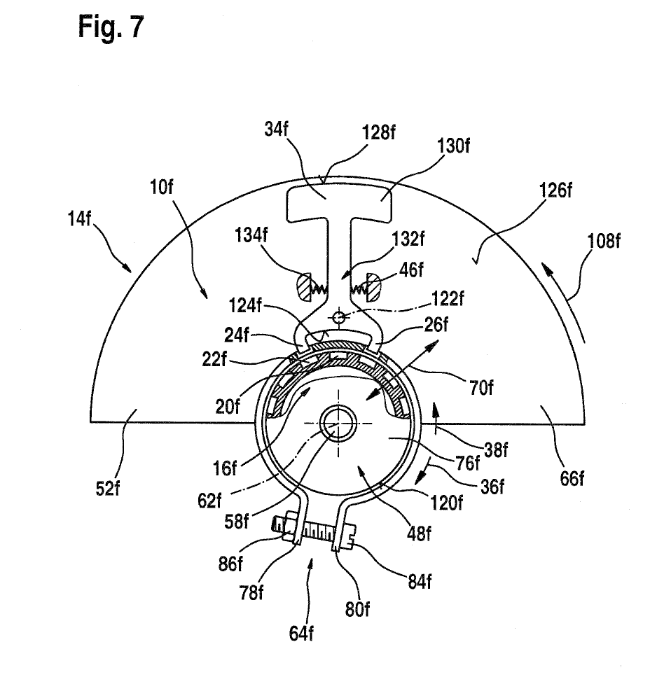

FIG. 7 shows an alternative embodiment of guard anti-rotation lock device 10f. Guard anti-rotation lock device 10f includes a form-fit connection unit 16f, which is provided to prevent rotation between a guard unit and a receiving unit 48f of a hand-held power tool if a tool should burst. Form-fit connection unit 16f includes several form-fit connection elements 20f, 22f, which are located one after the other in a circumferential direction 36f, 38f, and each of which is formed by a recess and extends inwardly in a radial direction 70f away from an outwardly oriented surface 120f of a receiving flange 76f of receiving unit 48f. In addition, form-fit connection element 16f includes two further form-fit connection elements 24f, 26f, which are designed as single pieces with a driving element 34f—which is designed as an oscillating element—and which are supported together with driving element 34f on guard unit 14f such that they may oscillate around a pivot axis 122f. Form-fit connection elements 24f, 26f are located on a radially inwardly facing side 124f of the oscillating element, which—in an installed state of the hand-held power tool system—is located on a surface 126f—which faces a tool—of a guard body 66f. Form-fit connection elements 24f, 26f extend inwardly in radial direction 70f, away from the oscillating element. The oscillating element includes—on a side 128f facing away from form-fit connection elements 24, 26f—an oscillating weight 130f, and is secured in a position—before an anti-rotation lock is implemented—in a central subregion 132f via two retaining elements 46f, 134f designed as spring elements. When guard unit 14f is struck by an outwardly-slung tool piece when a tool bursts, guard unit 14f is affected by an impulse in a rotation direction 108f of the tool. The oscillating element is deflected out of its neutral position, and one of the two form-fit connection elements 24f, 26f engages in one of the recesses in receiving unit 48f, thereby preventing guard unit 14f from rotating further.

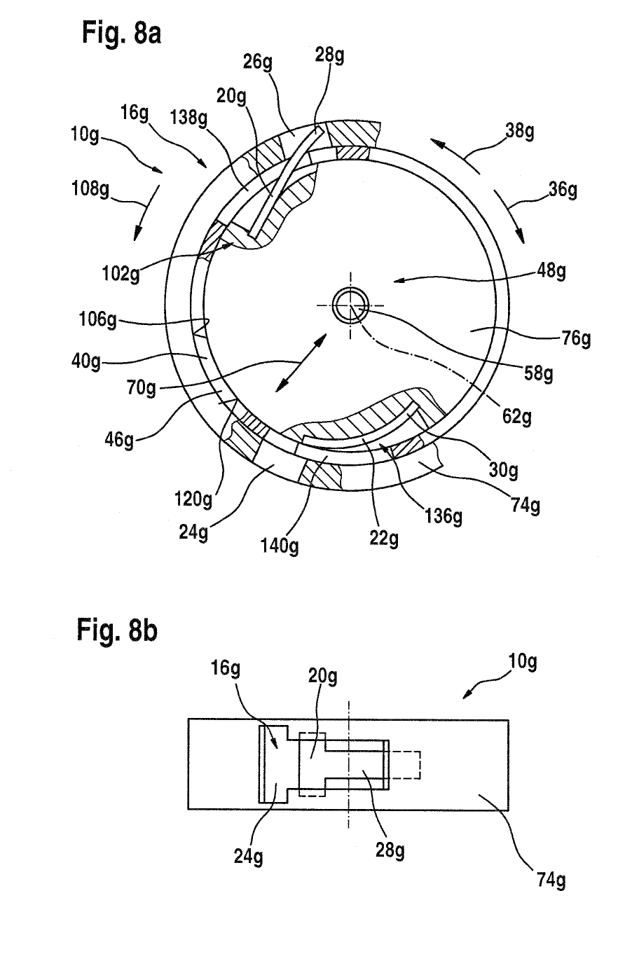

An alternative design of a guard anti-rotation lock 10g is shown in FIGS. 8a and 8b. Guard anti-rotation lock device 10g includes a form-fit connection unit 16g, which is provided to prevent rotation between a guard unit and a receiving unit 48g of a hand-held power tool if a tool should burst. Form-fit connection unit 16g includes two form-fit connection elements 20g, 22g, each of which is formed by a detent element 28g, 30g, and which are movably located within receiving unit 48g on edge regions 102g, 136g which are diametrically opposed in circumferential direction 36g, 38g. Detent elements 28g, 30g are designed as spring elements, and, in a neutral position before an anti-rotation lock is implemented, are located inside receiving unit 48g and are preloaded against a spring force. To this end, receiving unit 48g includes an intermediate ring 40g designed as a retaining element 46g, which is rotatably located on a radially outwardly oriented surface 120g of a receiving flange 76g. Intermediate ring 40g is secured via a not-shown release-prevention mechanism from accidentally rotating on receiving flange 76g. Further form-fit connection elements 24g, 26g are located on a clamping band 74g and/or a guard collar, and they are designed as recesses. Intermediate ring 40g couples in a non-positive manner to clamping band 74g and/or the guard collar, so that, if a tool should burst, it releases an anti-rotation lock position of form-fit connection elements 20g, 22g. To this end, intermediate ring 40g also includes recesses 138g, 140g, via which detent elements 28g, 30g extend into the recesses in clamping band 74g and/or the guard collar.

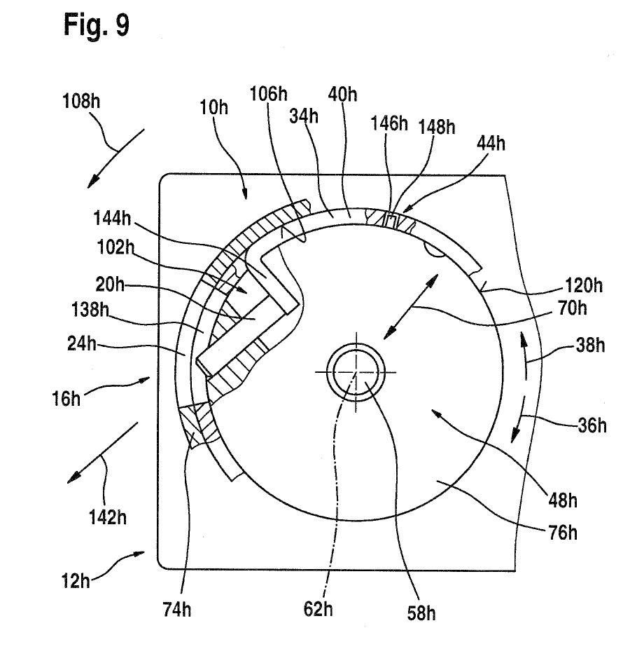

FIG. 9 shows an alternative embodiment of guard anti-rotation lock device 10h. Guard anti-rotation lock device 10h includes a form-fit connection unit 16h, which is provided to prevent rotation between a guard unit and a receiving unit 48h of a hand-held power tool 12h if a tool should burst. Form-fit connection unit 16h includes a form-fit connection element 20h, which is movably supported inside receiving unit 48h and is designed as a bolt. Form-fit connection element 20h is movable in an outward direction into an anti-rotation lock position of receiving unit 48h via a driving element 34h, which is designed as an intermediate ring 40h. A moving direction 142h of form-fit connection element 20h extends diagonally to radial direction 70h in a rotation direction 108h of the tool. A maximum angle of inclination of form-fit connection element 20h relative to radial direction 70h is 45°. To this end, intermediate ring 40h includes a peg-shaped element 144h that is bent inwardly in radial direction 70h, which moves form-fit connection element 20h into an anti-rotation lock position when intermediate ring 40h rotates in rotation direction 108h. Intermediate ring 40h is also held in a neutral position—before an anti-rotation lock is implemented—relative to receiving unit 48h via a release-prevention mechanism 44h. Release-prevention mechanism 44h includes a securing element 146h—which is designed as a recess—on intermediate ring 40h, in which a securing element 148h—designed as a raised area—of receiving unit 48h is supported. Intermediate ring 40h is driven via a motion of the guard unit into an anti-rotation lock position in the manner described with reference to FIG. 8, and an anti-rotation lock with the guard unit is implemented via form-fit connection element 20h in a manner described with reference to FIG. 2.

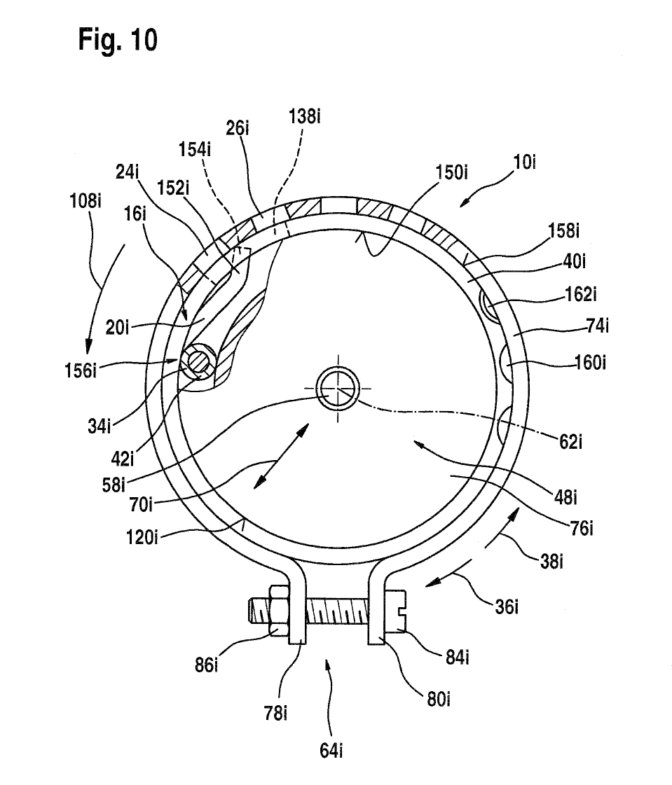

FIG. 10 shows an alternative embodiment of guard anti-rotation lock device 10i. Guard anti-rotation lock device 10i includes a form-fit connection unit 16i, which is provided to prevent rotation between a guard unit and a receiving unit 48i of a hand-held power tool if a tool should burst. Form-fit connection unit 16i includes a form-fit connection element 20i, which is designed as a single piece with an intermediate ring 40i of receiving unit 48i. Form-fit connection element 20i is designed as a tab, which projects outwardly from a side 150i—which faces inwardly in radial direction 70i—of intermediate ring 40i, and which extends away from intermediate ring 40i opposite to a rotation direction 108i of a tool. On an end 152i facing away from intermediate ring 40i, the tab includes a hook element 154i, which is designed as a single piece with the tab. Hook element 154i extends diagonally outward. Furthermore, form-fit connection unit 16i includes a driving element 34i, which is designed as a rolling element 42i that is rotatable in circumferential direction 36i, 38i, and which is located inside receiving unit 48i on inwardly-facing side 150i of intermediate ring 40i. Rolling element 42i bears along circumferential direction 36i, 38i in a region 156i of intermediate ring 40i, on which form-fit connection element 20i is located. Intermediate ring 40i couples in a form-fit manner with a clamping band 74i and/or a guard collar of the guard unit. To this end, intermediate ring 40i includes—on a surface 158i that faces outward in radial direction 70i—several coupling elements 160i designed as notches. Correspondingly, clamping band 74i and/or the guard collar include(s) a coupling element 162i that is designed as a raised area that extends inwardly in radial direction 70i. When the guard unit is in an installed working position on the hand-held power tool, coupling elements 160i, 162i engage in each other in a form-fit manner. If the guard unit is struck by an outwardly-slung tool piece when a tool bursts, and the guard unit is moved together with intermediate ring 40i in rotation direction 108i, rolling element 42i walks around intermediate ring 40i and the tab is pressed outwardly in radial direction 70i and extends through a recess 138i in intermediate ring 40i in one of several form-fit connection elements 24i, 26i which are designed as recesses in the guard unit.

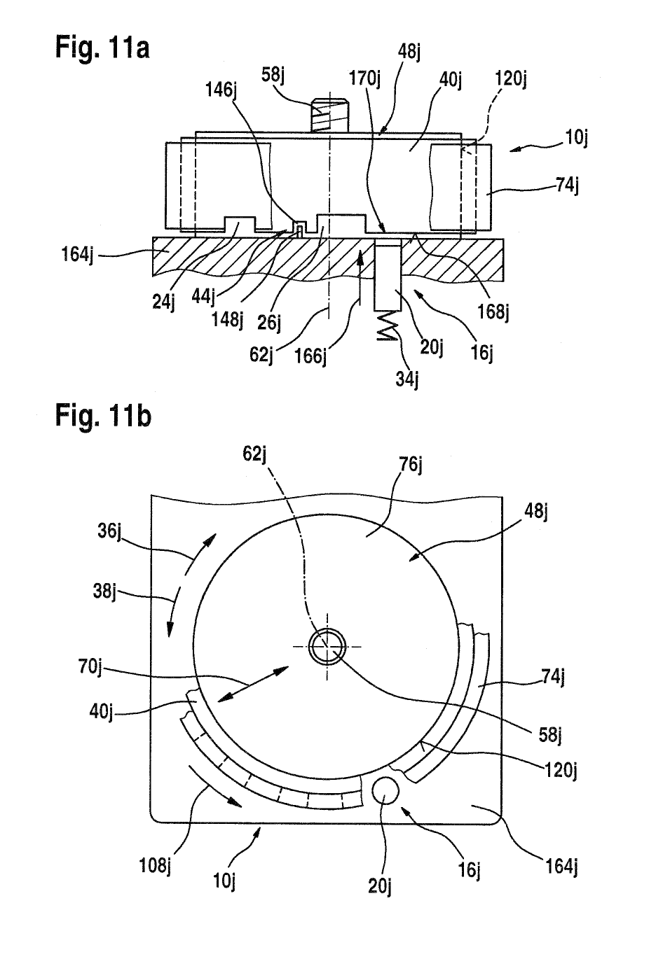

An alternative design of a guard anti-rotation lock 10j is shown in FIGS. 11a and 11b. Guard anti-rotation lock device 10j includes a form-fit connection unit 16j, which is provided to prevent rotation between a guard unit and a receiving unit 48j of a hand-held power tool if a tool should burst. Receiving unit 48j includes a form-fit connection element 20j of form-fit connection unit 16j, which is designed as a bolt and is located inside a main element 164j of receiving flange 76j. The bolt is supported such that it is movable along a direction 166j away from main element 164j in the direction of a free end of a drive shaft 58j in main element 164j. In addition, receiving unit 48j includes an intermediate ring 40j, which is located in circumferential direction 36j, 38j around a receiving flange 76j, and is fixed in a neutral position—before an anti-rotation lock is implemented—on receiving flange 76j via a release-prevention mechanism 44h, which is designed as described with reference to FIG. 9. A clamping band 74j and/or a guard collar of the guard unit are located around intermediate ring 40j in a non-positive manner. Intermediate ring 40j and clamping band 74j and/or the guard collar include form-fit connection elements 24j, 26j of form-fit connection unit 16j—designed as recesses—on a side 168j facing main element 164j. When the guard unit is in an installed working position, the bolt is supported by a recess-free subregion 170j of clamping band 74j and/or the guard collar together with intermediate ring 40j in main element 164j against a spring force of a driving element 34j, which is designed as a spring element. When the guard unit is rotated out of its working position together with intermediate ring 40j, as is the case when a tool bursts, recess-free subregion 170j is rotated away from the bolt, and the bolt moves due to spring force in direction 166j and engages in one of the form-fit connection elements 24j, 26j, thereby halting a rotation between the guard unit and the hand-held power tool.

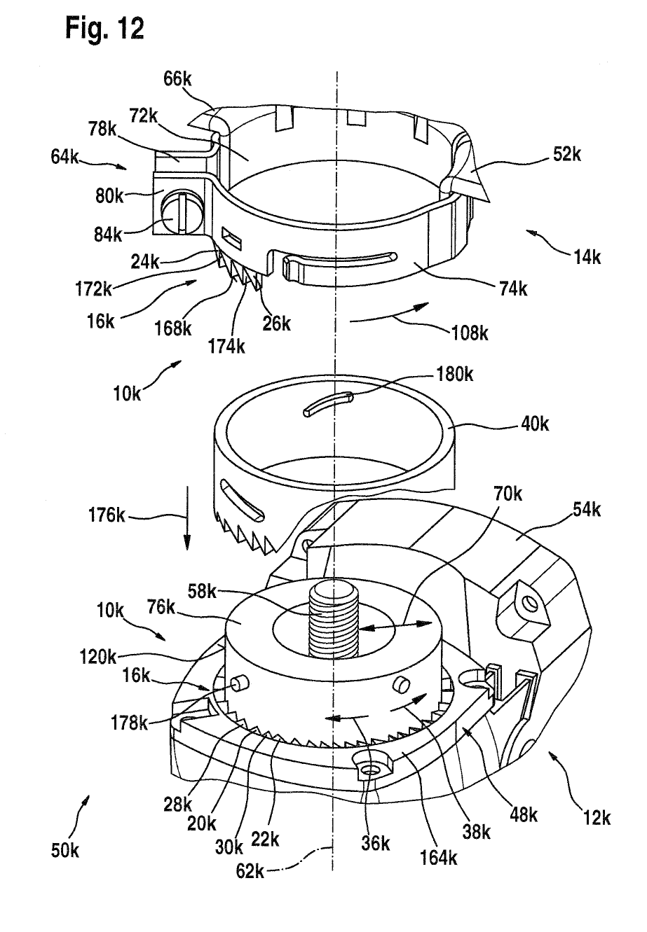

FIG. 12 shows an alternative embodiment of guard anti-rotation lock device 10k of a hand-held power tool system 50k. Guard anti-rotation lock device 10k includes a form-fit connection unit 16k, which is provided to prevent rotation between a guard unit 14k and a receiving unit 48k of a hand-held power tool 12k if a tool should burst. Form-fit connection unit 16k includes several form-fit connection elements 20k, 22k, which are designed as single pieces with receiving unit 48k, and several form-fit connection elements 24k, 26k, which are designed as single pieces with a clamping band 74k of guard unit 14k. Form-fit connection elements 20k, 22k, 24k, 26k are designed as detent elements 28k, 30k 172k, 174k, which, when engaged, prevent guard unit 14k from rotating relative to hand-held power tool 12k in a rotation direction 108k of the tool. Form-fit connection elements 20k, 22k of receiving unit 48k are located in radial direction 70k downstream of an outwardly directed side 124k of a receiving flange 76k in a main element 164k of receiving unit 48k. Form-fit connection elements 24k, 26k are located on clamping band 74k on a side 168k facing main element 164k and away from clamping band 74k in a direction 176k away from guard body 66k and toward main element 164k. Direction 176k is oriented parallel to an axis 62k of a drive shaft 58k. Receiving unit 48k includes an intermediate ring 40k, which is connected with receiving flange 76k in a form-fit manner. To this end, receiving flange 76k includes several bolt-shaped coupling elements 178k, which are distributed in circumferential direction 36k, 38k and are supported in corresponding slots 180k in intermediate ring 40k. Slots 180k include—in rotation direction 108k—a bevel that points in direction 176k, which has a maximum angle of inclination to rotation direction 108k of 450. When guard unit 14k rotates, together with intermediate ring 40k, in rotation direction 108k, intermediate ring 40k is moved together with guard unit 14k in direction 176k of main element 164k, and form-fit connection elements 20k, 22k, 24k, 26k of receiving unit 48k and guard unit 14k engage in each other, thereby preventing guard unit 14k from rotating.

What is claimed is:

1. A guard anti-rotation lock device for a hand-held power tool (12a-k), in particular for an angle grinder, which is provided to prevent rotation between the hand-held power tool (12a-k) and a guard unit (14a-k), characterized by a form-fit connection unit (16a-k), which is provided to prevent the guard unit (14a-k) from rotating relative to hand-held power tool (12a-k) if a tool (18a-k) should burst.

2. The guard anti-rotation lock device as recited in claim 1,
wherein
the form-fit connection unit (16a-j) includes at least one form-fit connection element (20a; 20b; 20c; 20d; 20e, 22e; 24f, 26f; 20g, 22g; 20h; 20i; 20j), which is movably supported on the guard unit (14f) and/or the hand-held power tool (12a-e; 12g-j).

3. The guard anti-rotation lock device as recited in claim 2,
wherein
the form-fit connection element (24f, 26f) is supported on the guard unit (14f) such that it is movable around a pivot axis (122f).

4. The guard anti-rotation lock device as recited in claim 2,
wherein
the form-fit connection unit (16c-e) includes a guide element (32c-e), in which the form-fit connection element (20c-e) is movably supported.

5. The guard anti-rotation lock device as recited in claim 1,
wherein
the form-fit connection unit (16a-k) includes at least one form-fit connection element (24a-e, 26a-e; 20a, 22a; 24g, 26g; 24h-j, 26i-j; 20k, 22k, 24k, 26k), which is designed at least partially as a single piece with the guard unit (14a-e; 14g-k) and/or the hand-held power tool (12f; 12k).

6. The guard anti-rotation lock device as recited in claim 2,
wherein
the form-fit connection element (20e, 22e, 24e, 26e; 20g, 22g, 24g, 26g; 20k, 22k, 24k, 26k) is formed at least partially by a detent element (28e, 30e; 28g, 30g; 28k, 30k, 172k, 174k).

7. The guard anti-rotation lock device as recited in claim 2,
wherein
the form-fit connection element (20a-e, 22e; 24f, 26f; 20g, 22g; 20h-j; 20k, 22k) is movable together with the guard unit (14a-k) into an anti-rotation lock position.

8. The guard anti-rotation lock device as recited in claim 7,
wherein
the form-fit connection element (20a-d; 20e, 22e; 20g, 22g; 20h; 20j) is provided to couple in at least partially non-positive manner with the guard unit (14a-e; 14g-h; 14j).

9. The guard anti-rotation lock device as recited in claim 1,
wherein
the form-fit connection unit (16c-f; 16h-j) includes at least one driving element (34c-f; 34h-j), which is provided to drive at least one form-fit connection element (20a-d; 20e, 22e; 24f, 26f; 20h-j) into an anti-rotation lock position together with the guard unit (14c-f; 14h-j).

10. The guard anti-rotation lock device as recited in claim 9,
wherein
the driving element (34c-e; 34h; 34j) is provided to couple in at least partially non-positive manner to the guard unit (14c-e; 14h; 14j) in a circumferential direction (36c-e, 38c-e; 36h, 38h; 36j, 38j).

11. The guard anti-rotation lock device as recited in claim 9,
wherein
the driving element (34h) is designed as an intermediate ring (40h).

12. The guard anti-rotation lock device as recited in claim 9,
wherein
the driving element (34i) is designed as a rolling element (42i).

13. The guard anti-rotation lock device as recited in claim 1,
wherein
the form-fit connection unit (16c; 16d; 16h; 16j) includes at least one release-prevention mechanism (44c; 44d; 44h; 44j), which is provided to fix at least one driving element (34c; 34d; 34h; 34j) and/or a form-fit connection element (20c; 20d; 20h; 20j) in a neutral position before an anti-rotation lock.

14. The guard anti-rotation lock device as recited in claim 1,
wherein
the form-fit connection unit (16a; 16f; 16g) includes at least one retaining element (46a, 46f, 134f; 46g), which is provided to secure at least one form-fit connection element (20a; 24f, 26f; 20g, 22g) in a position before an anti-rotation lock.

15. A hand-held power tool system with a hand-held power tool (12a-k), in particular an angle grinder, a guard unit (14a-k), and a guard anti-rotation lock device (10a-k) as recited in claim 1,
wherein
the guard anti-rotation lock device (10a-k) includes a form-fit connection unit (16a-k), which is provided to prevent the guard unit (14a-k) from rotating relative to the hand-held power tool (12a-k) if a tool (18a-k) should burst.

16. The hand-held power tool system as recited in claim 15,
wherein
the form-fit connection unit (16a-j) includes at least one form-fit connection element (20a; 20b; 20c; 20d; 20e, 22e; 24f, 26f; 20g, 22g; 20h; 20i; 20j), which is movably supported on the guard unit (14f) and/or the hand-held power tool (12a-e; 12g-j).

17. The hand-held power tool system as recited in claim 15,
wherein
the guard unit (14f) includes a guard (52f) on which the form-fit connection element (24f, 26f) is supported such that it is movable around a pivot axis (122f).

18. The hand-held power tool system as recited in claim 15,
wherein
the hand-held power tool (12a-e; 12g-j) includes a receiving unit (48a-e; 48g-j), which is provided to movably support the form-fit connection element (20a; 20b; 20c; 20d; 20e, 22e; 20g, 22g; 20h; 20i; 20j).

19. The hand-held power tool system as recited in claim 15,
wherein
the hand-held power tool (12i; 12j) includes a receiving unit (48i; 48j) with an intermediate ring (40i; 40j), on which the form-fit connection element (20i; 24j, 26j) is at least partially located.

20. The hand-held power tool system as recited in claim 15,
wherein
the form-fit connection unit (16a-g; 16i-k) includes at least two form-fit connection elements (24a-d, 26a-d; 20e-g, 22e-g, 24e-g, 26e-g; 24i-j, 26i-j; 20k, 22k, 24k, 26k), which are located one after the other in a circumferential direction (36a-g, 38a-g; 36i-k, 38i-k) on a receiving unit (48e-g; 48k) of the hand-held power tool (12e-g; 12k) and/or on the guard unit (14a-g; 14i-k).
